(19) United States
(12) Patent Application Publication
(10) Pub. No.: US 2025/0054910 A1
(43) Pub. Date: Feb. 13, 2025

(54) SYSTEMS AND METHODS FOR THREE-DIMENSIONALLY STACKING SYSTEMS ON CHIP WITH FACE-TO-FACE HYBRID BONDING

(71) Applicant: Meta Platforms Technologies, LLC, Menlo Park, CA (US)

(72) Inventors: Huseyin Ekin Sumbul, San Francisco, CA (US); Edith Dallard, San Mateo, CA (US); Fan Wu, Redwood City, CA (US); Huichu Liu, Santa Clara, CA (US); Lita Yang, Sunnyvale, CA (US); Matheus Trevisan Moreira, La Jolla, CA (US); Anuradha Krishnan, San Jose, CA (US); Gireesh Vijayakumar, Sunnyvale, CA (US); Valerio Catalano, San Francisco, CA (US)

(21) Appl. No.: 18/391,011

(22) Filed: Dec. 20, 2023

Related U.S. Application Data
(60) Provisional application No. 63/518,048, filed on Aug. 7, 2023.

(51) Int. Cl. H01L 25/065; H01L 25/00; H10B 10/00; H10B 80/00

(52) U.S. Cl. CPC H01L 25/0657; H01L 25/50; H10B 10/18; H10B 80/00; H01L 2225/06513; H01L 2225/06544

(57) ABSTRACT

A method for three-dimensionally stacking systems on chip with face to face hybrid bonding may include providing a first die including a driver gate driving a first via ladder coupled to a first top metal layer. The method may additionally include providing a second die including a load gate coupled to a second via ladder coupled to a second top metal layer. The method may also include stacking the first die and the second die three-dimensionally using face-to-face hybrid bonds to couple the first top metal layer to the second top metal layer. Various other methods, systems, and computer-readable media are also disclosed.

### CROSS REFERENCE TO RELATED APPLICATION

This application claims the benefit of U.S. Provisional Application No. 63/518,048, filed Aug. 7, 2023, the disclosure of which is incorporated, in its entirety, by this reference.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for three-dimensionally stacking systems on chip with face to face hybrid bonding.

FIG. 2 is an illustration of an exemplary standard cell driving a two-dimensional (2D) global wire in two dimensions (e.g., X and Y dimensions) on a single die.

FIG. 3 is an illustration of an exemplary standard cell driving a three-dimensional (3D) load in a third dimension (e.g., Z dimension) in addition to the two dimensions (e.g., X and Y dimensions) across two stacked dies over a hybrid bump.

FIG. 4 is an illustration of exemplary 3D forwarded clocks creating 3D spatially local cross die paths to enable closing of timing under multi-die variations for 3D integrated circuit (3DIC) partitioned static random access memory (SRAM) banks.

FIG. 5 is an illustration of an exemplary scaling and design method to multiple instances on an example 3DIC partitioned SRAM of 32× banks, with 16× banks implemented in a first die and 16× banks implemented in a second die.

FIG. 6 is an illustration of exemplary extension of a network on chip (NoC) connection to off-die by using 3D hybrid bumps to enable mitigation of external NoC communication bottleneck when compared to 2D input/outputs (IOs).

FIG. 7 is an illustration of exemplary extension of 3D NoC to achieve speed and energy efficiency comparable to 2D internal NoC communication.

FIG. 8 is an illustration of an exemplary static-cycle control flow for a pipelined data path.

FIG. 9 is an illustration of an exemplary dynamic-cycle control flow for a ready/valid based communications protocol based data path.

FIG. 10 is an illustration of an exemplary 2D static-cycle data path with six pipeline stages.

FIG. 11 is an illustration of an exemplary 2D static-cycle data path of FIG. 10 as extended with more memory with a stacked 3D memory die.

FIG. 12 is an illustration of exemplary dynamic-cycle data paths with flexible function blocks using hand-shake communication.

FIG. 13 is an illustration of exemplary augmented-reality glasses that may be used in connection with embodiments of this disclosure.

FIG. 14 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Augmented reality and virtual reality glasses (e.g., VR headsets, AR glasses, etc.) often benefit from inclusion of neural network accelerators. A neural network (NN) accelerator is a processor that is optimized specifically to handle neural network workloads. Such accelerators cluster and classify data efficiently and at a fast rate.

Future augmented reality (AR) and virtual reality (VR) applications will enable a multitude of features and functionalities such as assistance, navigation, recommendation, visual processing and graphics, speech, generative artificial intelligence (AI), and many more. These workloads may typically be compute-intensive, memory-intensive, or sometimes both. AR/VR wearable devices, however, have very tight power (e.g., limited battery) and area budgets (e.g., limited physical space within the industrial design specs). Therefore, to run the future AR/VR applications, mobile Systems on Chip (SoCs) have to provide high-performance and high compute capabilities and large, embedded memory capacity, while being low-power and low form-factor/area.

One key enabling technology is the advent of hybrid-bonded 3D die stacking technology, offering less than 10 μm (e.g., current) or 5 μm (e.g., near-future) pitch high-density 3D interconnects. This technology allows for expanding compute capabilities and memory capacities of a mobile SoC in 3D with high-density, high-bandwidth 3D connections to achieve small form-factor, high-performance, and energy-efficiency with a large, embedded memory capacity for running future AR/VR applications. However, extending an SoC to 3D with hybrid-bonded die-stacking is not a straightforward task and requires innovation in multiple levels of the design hierarchy.

The present disclosure is generally directed to systems and methods for three-dimensionally stacking SoCs with face-to-face hybrid bonding. For example, a semiconductor device may include a first die including a driver gate driving a first via ladder coupled to a first top metal layer and a second die including a load gate coupled to a second via ladder coupled to a second top metal layer. The first die and the second die may be stacked three-dimensionally using face-to-face hybrid bonds to couple the first top metal layer to the second top metal layer. Both dies may include both driver and load gates when stacked to achieve signal driving in both directions (i.e., top die-to-bottom die and bottom die-to-top die). Various implementations of this type of semiconductor device may include three-dimensional interconnects that correctly close timing at a SoC level, three-dimensional extension of an on-chip data communication fabric, and/or three-dimensional extension of hardware accelerators and/or static random access (SRAM) memories with minimal impact on an existing firmware and compiler for the SoC.

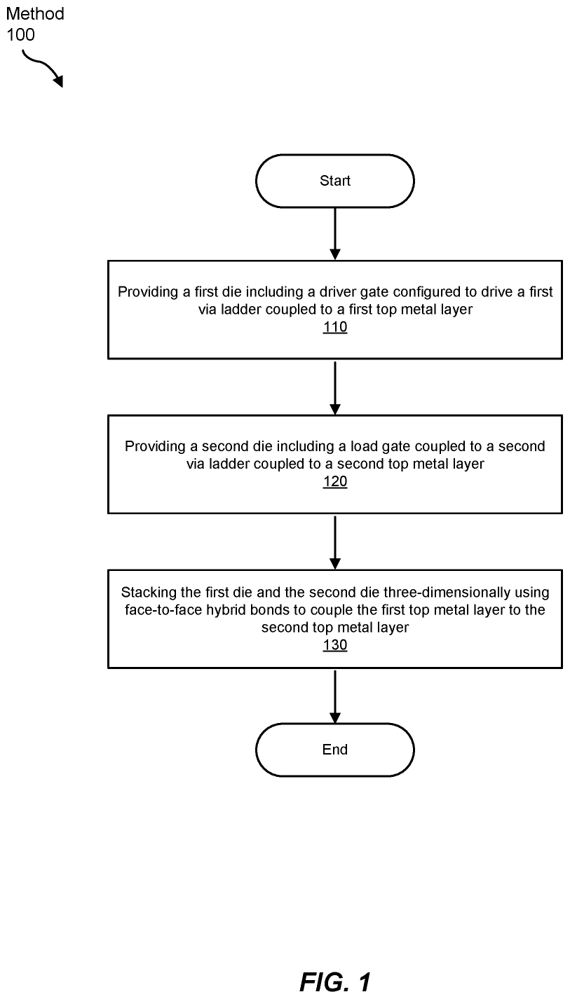

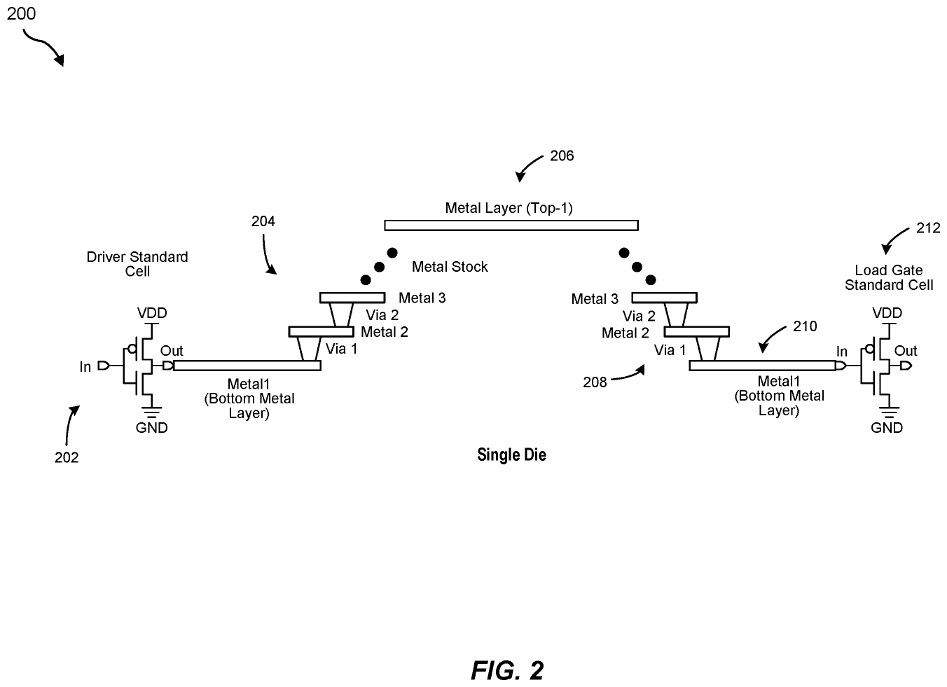

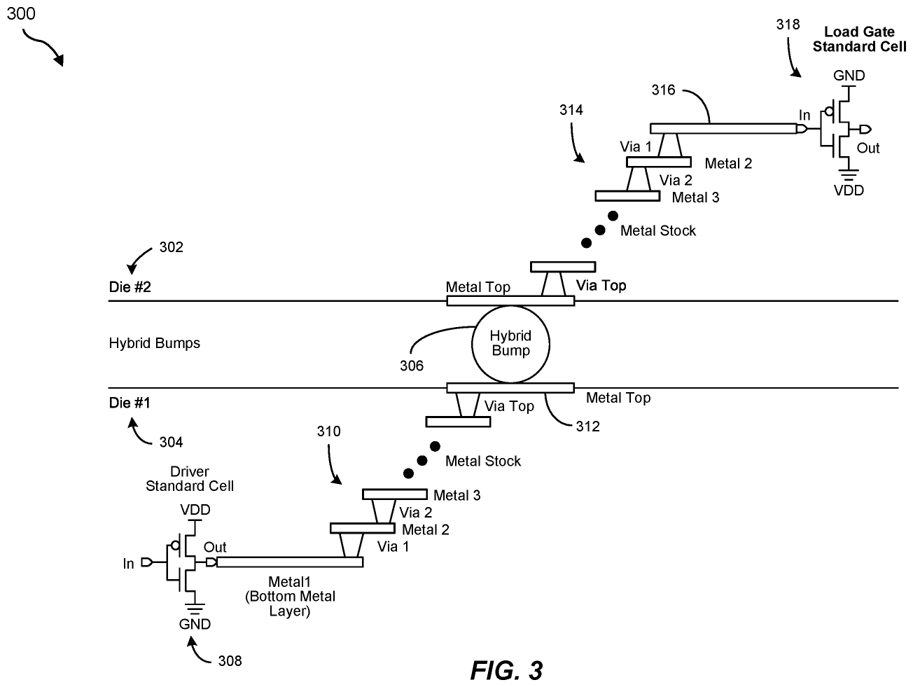

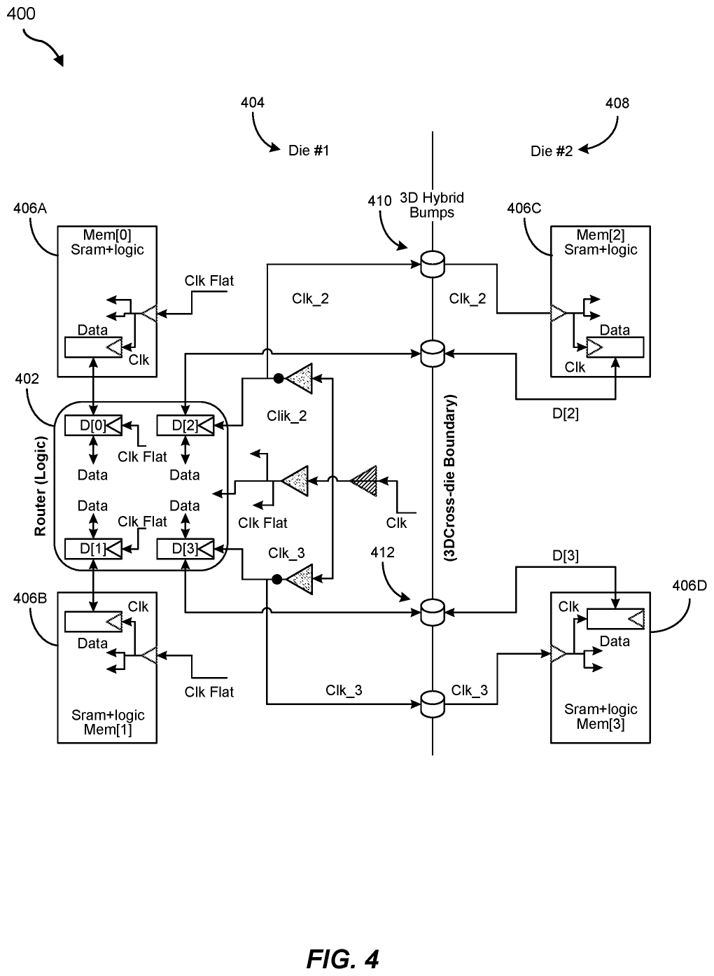

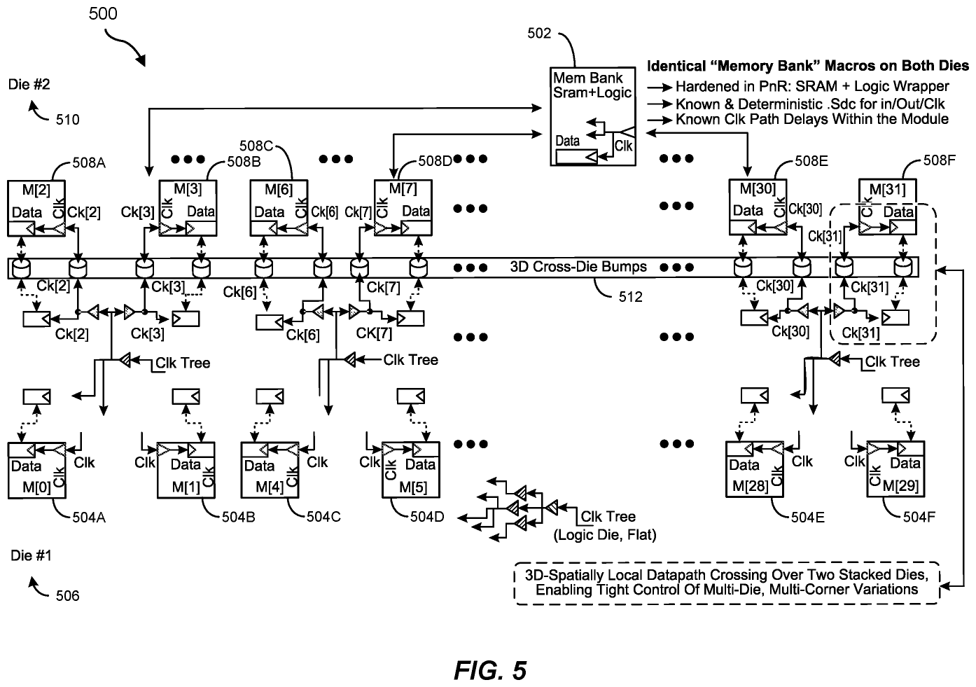

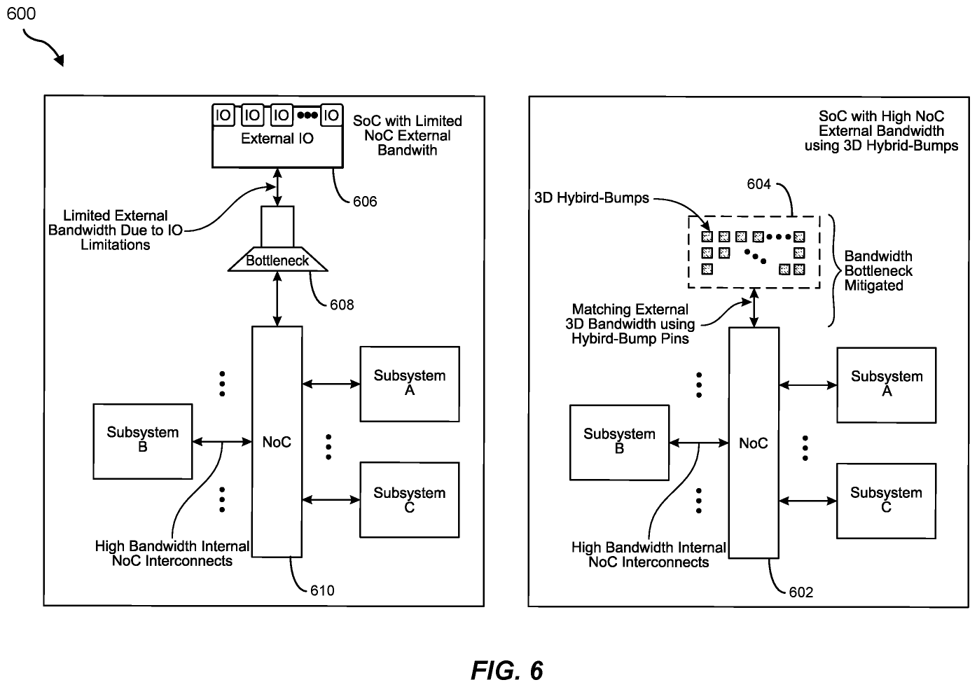

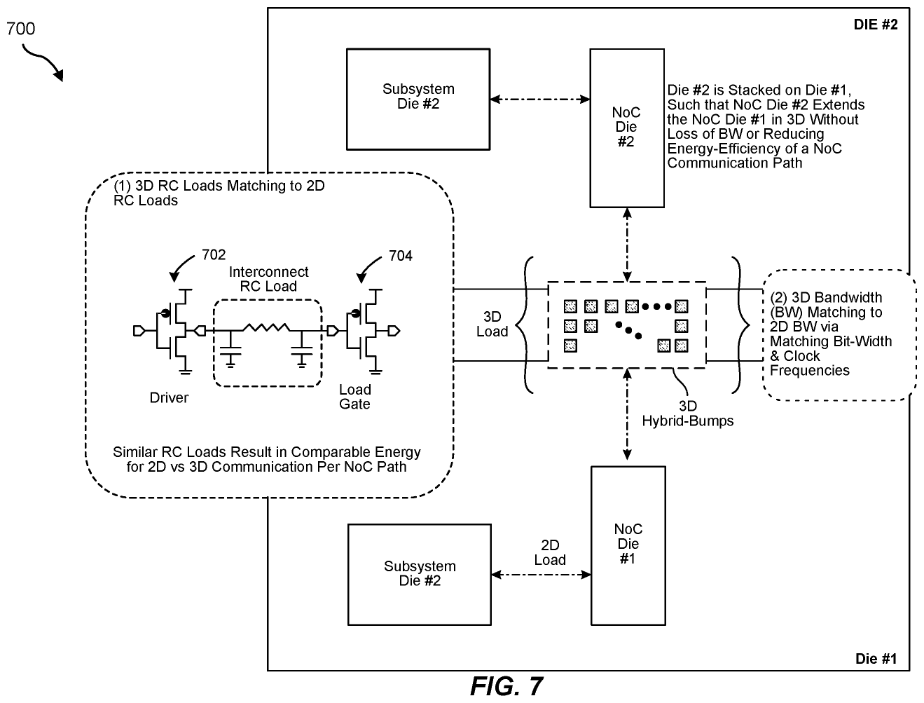

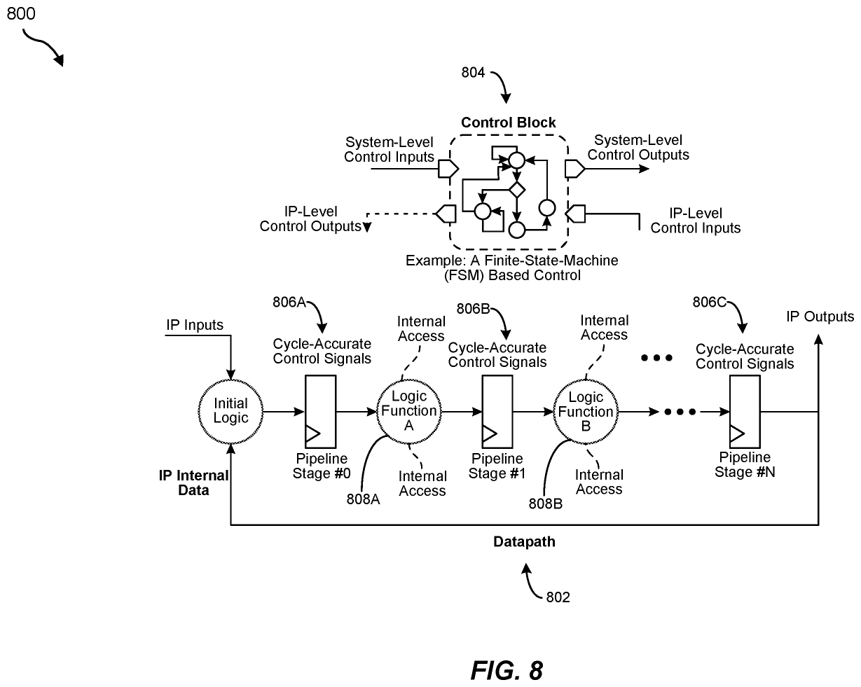

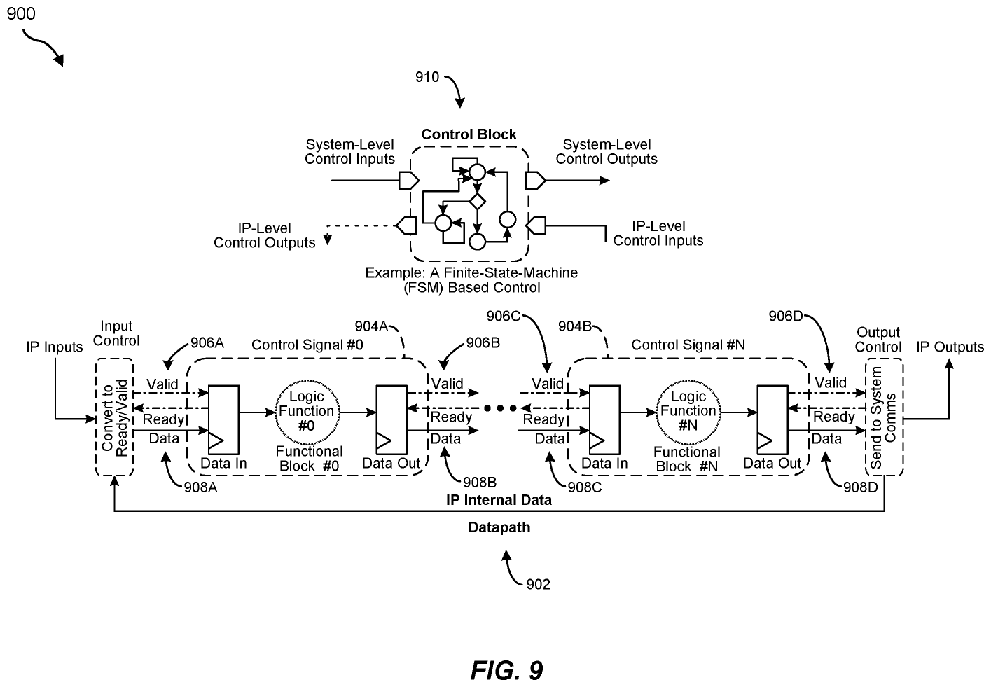

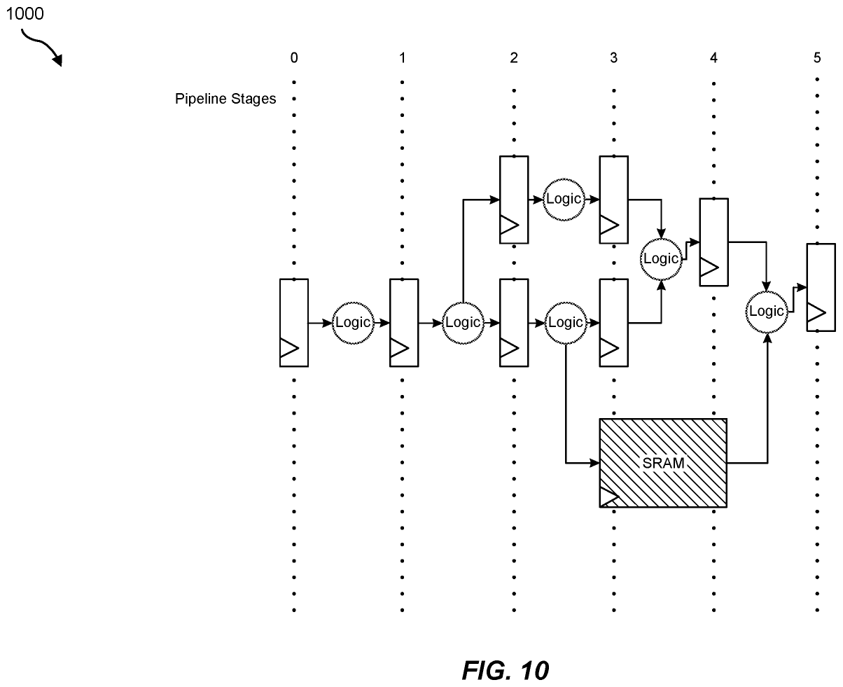

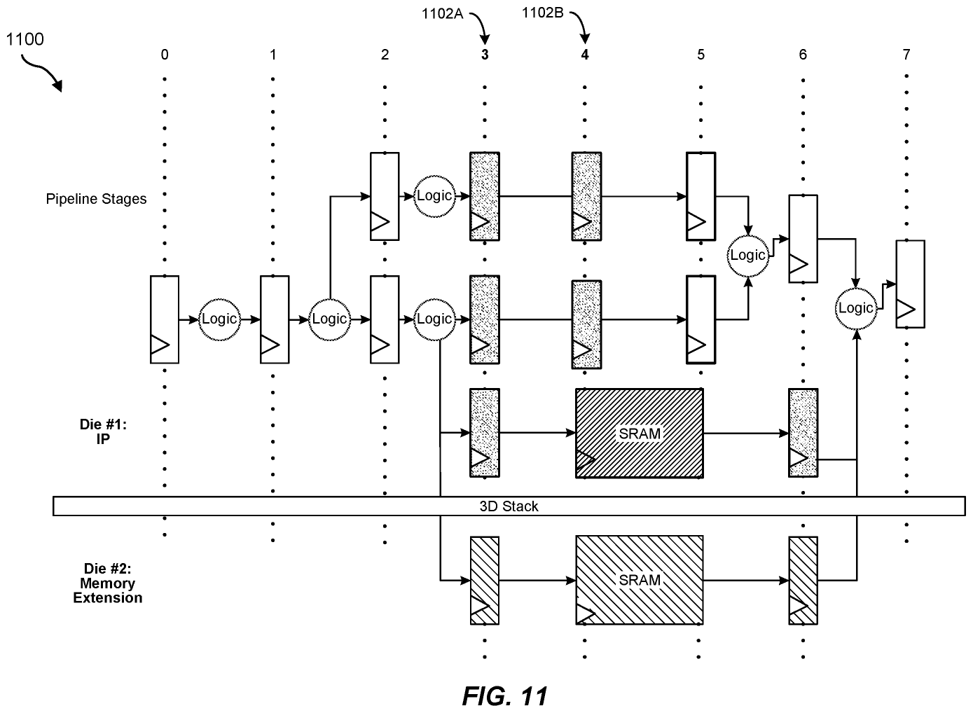

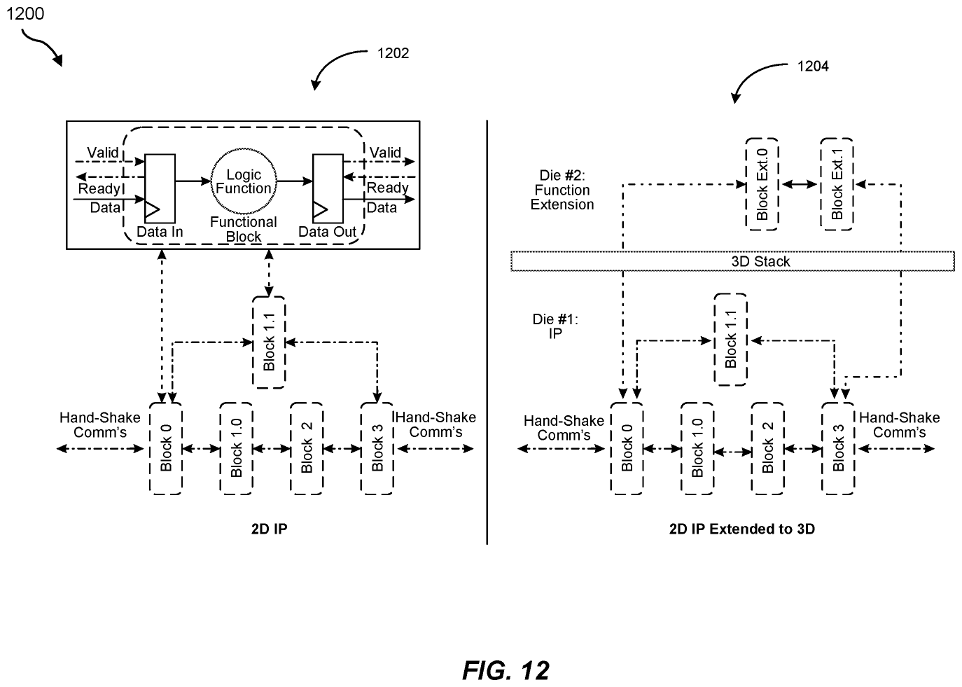

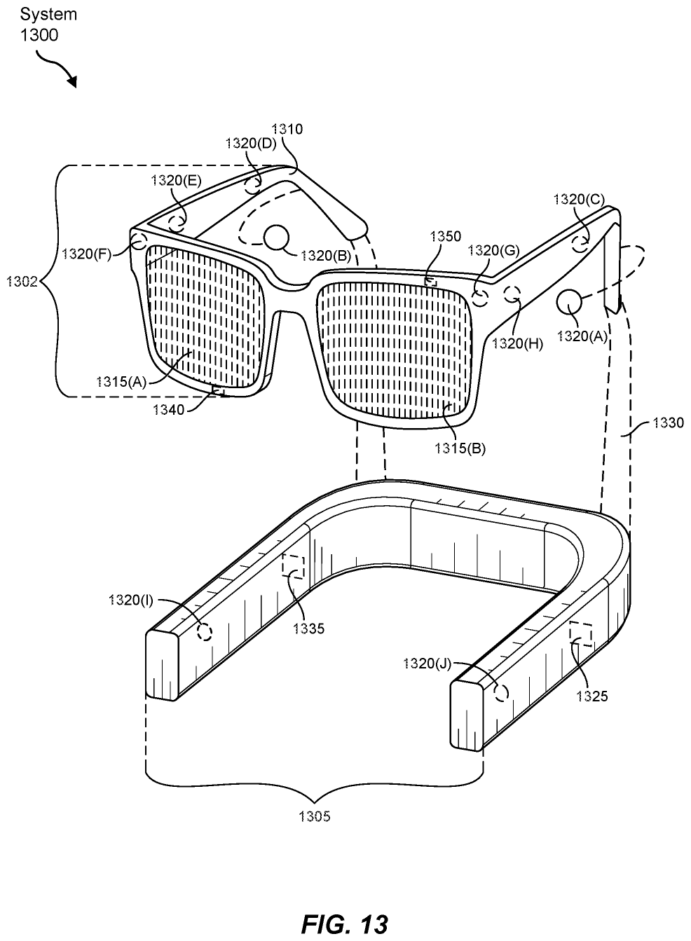

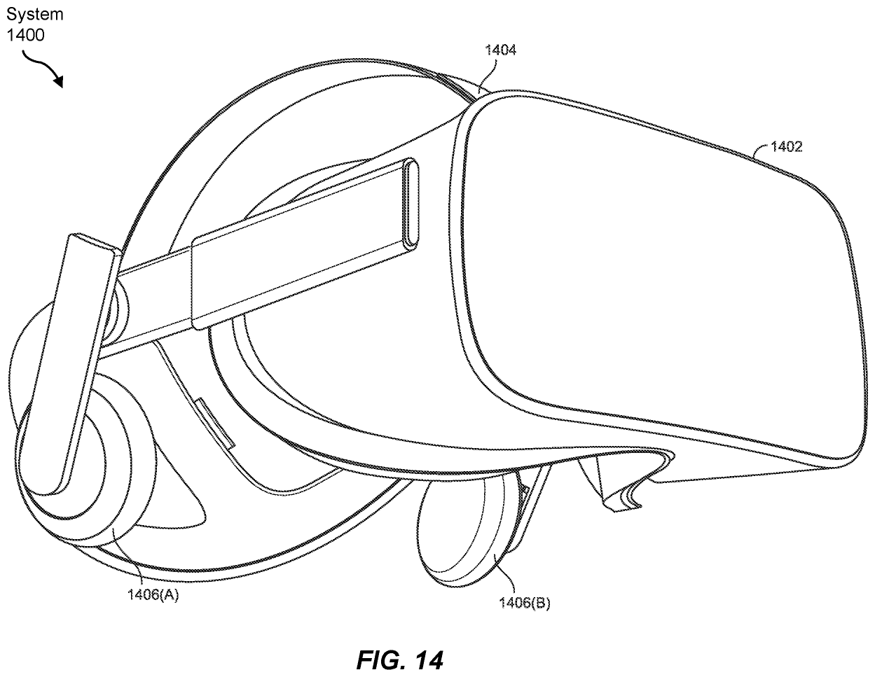

The following will provide, with reference to FIG. 1, detailed descriptions of exemplary methods for three-dimensionally stacking systems on chip with face to face hybrid bonding. Detailed descriptions of exemplary standard cells driving two-dimensional (2D) global wires in two dimensions (e.g., X and Y dimensions) on a single die are also provided with reference to FIG. 2. Additionally, detailed descriptions of exemplary standard cells driving three-dimensional (3D) loads in a third dimension (e.g., Z dimension) in addition to the two dimensions (e.g., X and Y dimensions) across two stacked dies over a hybrid bump are provided with reference to FIG. 3. Further, detailed descriptions of an exemplary 3D forwarded clocks creating 3D spatially local cross die paths to enable closing of timing under multi-die variations for 3D integrated circuit (3DIC) partitioned static random access memory (SRAM) banks are provided with reference to FIG. 4. Further, detailed descriptions of exemplary scaling and design methods to multiple instances on an example 3DIC partitioned SRAM of 32× banks, with 16× banks implemented in a first die and 16× banks implemented in a second die are provided with reference to FIG. 5. Further, detailed descriptions of exemplary extension of a network on chip (NoC) connection to off-die by using 3D hybrid bumps to enable mitigation of external NoC communication bottleneck when compared to 2D input/outputs (IOs) are provided with reference to FIG. 6. Further, detailed descriptions of exemplary extension of 3D NoC to achieve speed and energy efficiency comparable to 2D internal NoC communication are provided with reference to FIG. 7. Further, detailed descriptions of exemplary static-cycle control flows for pipelined data paths are provided with reference to FIG. 8. Further, detailed descriptions of exemplary dynamic-cycle control flows for ready/valid based communications protocol based data paths are provided with reference to FIG. 9. Further, detailed descriptions of exemplary 2D static-cycle data paths with six pipeline stages are provided with reference to FIG. 10. Further, detailed descriptions of the exemplary 2D static-cycle data paths of FIG. 10 as extended with more memory with a stacked 3D memory die are provided with reference to FIG. 11. Further, detailed descriptions of exemplary dynamic-cycle data paths with flexible function blocks using hand-shake communication are provided with reference to FIG. 12. Finally, detailed descriptions of exemplary augmented-reality glasses and virtual-reality headsets are provided with reference to FIGS. 13 and 14.

FIG. 1 is a flow diagram of an exemplary method 100 for three-dimensionally stacking systems on chip with face to face hybrid bonding. Beginning at step 110, method 100 may include providing a first die. For example, step 110 may include providing a first die including a driver gate configured to drive a first via ladder coupled to a first top metal layer.

The term “die,” as used herein, may generally refer to a thin piece of silicon. For example, and without limitation, a die may include a thin piece of silicon on which components, such as transistors, diodes, resistors, and other components, are housed to fabricate a functional electronic circuit. In this context, a “logic die” may correspond to a die that contains a majority of the logic components (e.g., transistors) of the electronic circuit of a semiconductor device. In contrast, a “memory die” may correspond to a die that contains a majority of the memory components (e.g., SRAM, DRAM, etc.) of the electronic circuit of a semiconductor device.

The term “driver gate,” as used herein, may generally refer to a power amplifier. For example, and without limitation, a driver gate may correspond to a power amplifier that accepts a low-power input from a controller IC and produces a high-current drive input for the gate of a high-power transistor such as an IGBT or power MOSFET. Driver gates may be provided either on-chip or as a discrete module. In essence, a driver gate may include a level shifter in combination with an amplifier. A driver gate IC may serve as an interface between control signals (e.g., digital or analog controllers) and power switches (e.g., IGBTs, MOSFETs, SiC MOSFETs, and GaN HEMTs). An integrated driver gate may reduce design complexity, development time, bill of materials (BOM), and board space while improving reliability over discretely-implemented driver gate solutions. In this context, a “load gate” may correspond to another gate (e.g., a fanout gate) that is driven by the driver gate.

The term “via ladder,” as used herein, may generally refer to a stacked via. For example, and without limitation, a via ladder may correspond to a stacked via that starts from a pin layer and extends into an upper layer where a router may connect to it. A via ladder may reduce the via resistance and thus improve performance and electromigration robustness.

The term “metal layer,” as used herein, may generally refer to a conductive pathway. For example, and without limitation a metal layer may include aluminum, nickel, chromium, gold, germanium, copper, silver, titanium, tungsten, platinum, and/or tantalum. Selected metal alloys may also be used. Metallization may often be accomplished with a vacuum deposition technique.

Step 110 may be performed in a variety of ways. In one example, a network on chip in the first die may connect partitioned subsystems of a circuit of the semiconductor device. Additionally or alternatively, a circuit of the die provided in step 110 may correspond to a processor of a neural network accelerator. Additionally or alternatively, memory of the die provided in step 110 may include static random access memory (SRAM), dynamic random access memory (DRAM), and/or wide input output DRAM (WIO-DRAM), etc.

At step 120, method 100 may include providing a second die. For example, step 120 may include providing a second die including a load gate coupled to a second via ladder coupled to a second top metal layer.

Step 120 may be performed in a variety of ways. In one example, a circuit of the die provided in step 110 may correspond to a processor of a neural network accelerator. Additionally or alternatively, memory of the die provided in step 110 may include static random access memory (SRAM), dynamic random access memory (DRAM), and/or wide input output DRAM (WIO-DRAM), etc.

At step 130, method 100 may include stacking the first die and the second die three-dimensionally. For example, step 130 may include stacking the first die and the second die three-dimensionally using face-to-face hybrid bonds to couple the first top metal layer to the second top metal layer.

The term “stacking,” as used herein, may generally refer to vertically arranging two or more integrated circuit dies one atop another. For example, and without limitation, multiple integrated circuits may be stacked vertically using, for example, through silicon via and/or copper to copper (Cu—Cu) connections so that they behave as a single device to achieve performance improvements at reduced power and smaller footprint compared to conventional two-dimensional processes.

The term “face-to-face,” as used herein, may generally refer to a bonding style in three-dimensional integrated circuits (3D ICs). For example, and without limitation, face-to-face bonding may bond integrated circuits by using the top-metals (e.g., faces) of two integrated circuits as the bonding sides when stacking the two integrated circuits. In contrast, face-to-back bonding may bond integrated circuits by using the top-metal (e.g., face) of only one of two integrated circuits as the bonding side when stacking the two integrated circuits.

The term “hybrid bonds,” as used herein, may generally refer to an extremely fine pitch Cu—Cu interconnect between stacked dies. For example, and without limitation, hybrid bonding may include stacking one die atop another die with extremely fine pitch Cu—Cu interconnect used to provide the connection between these dies.

Step 130 may be performed in a variety of ways. In one example, partitioned subsystems of a circuit of the semiconductor device may forward a single clock per partition. Additionally or alternatively, partitions of the partitioned subsystems may communicate exclusively with a common logic implemented in one of the first die or the second die. Additionally or alternatively, data communication across the first die and the second die may be implemented using sequential-to-sequential only data paths. Additionally or alternatively, a network on chip in the first die may connect partitioned subsystems of a circuit of the semiconductor device and cross die data communication by the network on chip may have a bit width matched to a pin density of the face-to-face hybrid bonds. Additionally or alternatively, all circuit drivers of the circuit may correspond to standard cell drivers. In some implementations, step 130 may include configuring a data path pipelined for a deterministic cycle count type control flow. In some of these implementations, step 130 may include implementing a three-dimensional extension of the data path by adjusting a deterministic timing data path by addition of additional pipeline stages and placement of a three-dimensional die crossing within one of the additional pipeline stages. In additional or alternative implementations, the additional pipeline stages may be empty pipeline stages and/or rebalanced pipeline stages. In any of these implementations or other implementations, step 130 may include configuring a data path having a flexible control flow based on at least one hand-shake protocol and implementing a three-dimensional extension of the data path as part of the at least one hand-shake protocol by addition of functional blocks and implementation of cross-die communication at a hand-shake interface for the functional blocks.

Extending an SoC to 3D with hybrid-bonded die-stacking is not a straightforward task and may include innovations in multiple levels of the design hierarchy. For example, the disclosed systems and methods present a complete 3D design methodology for a face-to-face (F2F) hybrid-bonded 3D stacked SoC. This methodology may include designing the 3D interconnects to correctly close timing at the SoC-level, extending the on-chip 2D communication fabric to 3D, and extending the 2D IPs (e.g., HW accelerators or SRAM memories) to 3D with minimal impact on the existing firmware and compiler for the SoC.

The disclosed systems and methods may implement three or more design techniques, alone or in combination, as a part of a complete 3D design methodology. For example, the disclosed systems and methods may address circuit design by implementing a 3D design methodology for high-density hybrid-bonding 3D interconnects using 3D clock forwarding to close timing at the SoC-level with built-in tolerance to multi-die variations. Alternatively or additionally, the disclosed systems and methods may address on-chip interconnect fabric by implementing an off-die extendible 3D Network-on-Chip (NoC) design methodology for 3D stacked dies with hybrid-bonding technology. Alternatively or additionally, the disclosed systems and methods may address IP extension to 3D by implementing compiler-agnostic 3D hardware IP extension for added memory and/or functionality with hybrid-bonding technology.

One feature common to many of the systems and methods disclosed herein may correspond to a 3D design approach with hybrid bumps. For example, hybrid bonding 3D interconnects may have near zero capacitance compared to micro-bumps resulting in minimal parasitic loads. As a result, the added RC load of a hybrid-bump may become very small when compared to the overall RC load of a global wire. In other words, driving a global wire in 2D vs. in 3D (i.e., specifically hybrid-bonded, and stacked face-to-face (F2F)) may correspond to a similar interconnect and parasitic load problem from a circuit design standpoint.

FIG. 2 illustrates an exemplary standard cell 200 driving a two-dimensional (2D) global wire in two dimensions (e.g., X and Y dimensions) on a single die. As shown in FIG. 2, a standard cell based driver's 202 2D load typically may be comprised of a via ladder 204 going up to one of the upper-level metal layers 206, a global wire at the driven metal layers, a via ladder 208 descending down to the bottom metal layer 210, and finally the gate capacitance of the load (i.e., a fanout gate 212).

FIG. 3 illustrates an exemplary standard cell 300 driving a three-dimensional (3D) load in a third dimension (e.g., Z dimension) in addition to the two dimensions (e.g., X and Y dimensions) across two stacked dies 302 and 304 over a hybrid bump 306. In comparison to the cell 200 of FIG. 2, a similar scenario for a 3D wire may correspond to the cell 300 of FIG. 3. For example, cell 300 may include a driver gate 308 configured to drive a via ladder 310 going up to a top-level metal 312 layer in the first die 304, a 3D hybrid-bump 306 that may connect to cross dies (e.g., from the first die 304 to a second die 302). This hybrid bump 306 may then connect to a via-ladder 314 descending down to the bottom metal layer 316 to drive the gate capacitance of the driver's fanout gate 318 in the second die 302.

As the added load of crossing dies in 3D using hybrid-bumps is small compared to the overall interconnect load for medium to long distance wires, driving a 3D wire with a hybrid-bump may be implemented similarly to a conventional 2D wire. From a circuit design standpoint, this means that both cell 200 of FIG. 2 and cell 300 of FIG. 3 may be implemented using the same electronic design automation (EDA) flows without the need for any specialized circuits. This implementation may enable routing in the Z-dimension in addition to the X and Y dimensions using standard cells.

In summary, this technology may enable implementation of a cell with various capabilities. For example, such a cell may extend the 2D circuits to 3D using standard cell libraries without any specialized circuits. Additionally, such a cell may use existing EDA flows and RTL generators to implement 3D IPs. Also, such a cell may open up new architectural opportunities, such as shorter 3D distances compared to long 2D distances, thus achieving better performance and energy-efficiency due to the energy spent for bits traveling in millimeters may be reduced. Implementations of the disclosed systems and methods may use this approach in any or all of the following example implementations.

Turning now to FIG. 4 and FIG. 5, the disclosed systems and methods may implement a 3D design methodology for high-density hybrid-bonding 3D interconnects using 3D clock forwarding to close timing at the SoC-level with built-in tolerance to multi-die variations. These implementations may address issues relating to on-chip variation (OCV) challenges that, for a multi-die stacked 3DIC SoC using hybrid-bumps, may be exacerbated since the implementation needs to consider the combined effects of multiple die variations at the same time. For example, if the cross-die 3D paths are not designed carefully to tolerate the variation effects of the combined multi-die variations, these cross-die paths may have timing closure issues, leading to functional failures in the circuit and in the fabricated SoC and thus drastically lowering the final yield.

Verifying these paths for correct timing closure may also benefit from extensive and long simulations with the state-of-the-art EDA and CAD tools (or similarly, IC design signoff tools), since each die has multiple Process, Voltage, Temperature corners (e.g., slow, fast, typical, etc.) along with multiple wire Resistance, Capacitance, Cross-Coupling parasitics models (i.e., best, worst, typical, etc.). If no 3D design considerations are implemented for the cross-die clock timing while covering each of the possible combinations of the variation sources, then closing timing on each combination may be either too time consuming or sometimes even an unsolvable task for the EDA tool due to bad cross-path timing design by construction.

To address these issues, the disclosed systems and methods may enable a scalable approach when implementing a 3D partitioned memory and logic block (e.g., a 3D extended SRAM of multiple MBs) that the state-of-the-art and conventional 2D EDA implementation tools may use. This approach may mitigate multi-die variation issues by balancing the timing on cross-die 3D data paths via implementing spatially-local 3D clock and signal sections using 3D forwarded-clocks. This approach may also allow for the state-of-the-art (SOTA) EDA tools to close timing even under numerous combinations of multi-die corner verifications for chip signoff.

FIG. 4 illustrates exemplary 3D forwarded clocks 400 creating 3D spatially local cross die paths to enable closing of timing under multi-die variations for 3D integrated circuit (3DIC) partitioned static random access memory (SRAM) banks. In this example, the disclosed systems and methods may be demonstrated with respect to a 3DIC partitioned SRAM with multiple memory banks distributed to two 3D stacked dies. As such, this approach may be demonstrated herein with reference to a 3D SRAM subsystem. However, this same approach may be applicable to any similarly 3D partitioned subsystem in a 3D stacked SoC.

As shown in FIG. 4, the disclosed systems and methods may implement a router logic for accessing the 3D partitions. For example, the 3D partitioned 3D SRAM subsystem may be implemented with a router logic 402 that may access multiple banks in a manner similar to how 2D memory partition read/write access is performed in conventional designs.

Router logic 402 may be implemented on one die 404 and communicate with each 3D SRAM Memory Bank 406A, 406B, 406C, and 406D on both dies, including die 404 and an additional die 408, through dedicated data ports D[0], D[1], D[2], and D[3], exclusive to each bank 406A-406D. For example, Data port D[0] may only communicate with 3D SRAM Memory Bank 406A while data port D[1] may only communicate with 3D SRAM Memory Bank 406B, etc.

Memory banks 406A-406D on either die 404 and/or 408 may not communicate with each other directly, and all communication may be handled through the router logic 402. For example, Mem[n] may exclusively communicate with DataPort[n] in the router logic 402, and any write/read operation in between MEM banks 406A-406D may be handled through the router logic 402 (e.g., data copying operation from one bank to another bank).

As shown in FIG. 4, 3D clock clk_2 and clk_3 forwarding 410 and 412 may be implemented with memory partition modules (e.g., 1 MB SRAM+logic wrappers) in the memory banks 406A-406D that may be hardened in place and by routing (i.e., PnR) for ease of use in the EDA tool flows. This approach may make all memory banks 406A-406D in the 3D SRAM module identical modules in terms of timing and input-output constraints. Therefore, in/out/clock insertion delays at the memory module level may be known exactly as pin constraints for a given memory bank 406A-406D by the EDA tool prior to top-level placement and integration. All 3D connections may also be implemented as sequential to sequential (e.g., “flop-to-flop”) data path connections. As a result, the disclosed systems and methods may avoid combinatorial loop-back paths on 3D cross-die passing that may create an unknown timing path during the top-level PnR flow for the EDA tool. Additionally, 3D Clocks may be locally forwarded as “generated clocks” in the POR EDA flow in the 3D direction. These 3D clock(s) may be exclusive to each memory bank. For example memory bank 406C may receive clk_2 only and memory bank 406D may receive clk_3 only. As a result, this exclusivity may provide local-only 3D cross-die boundary passing for each data port, memory port, and the forwarded 3D clock. In this context, “local” may refer to being controlled by the same generated clock and in close spatial proximity (e.g., local in X, Y, and Z directions).

Combining the router logic 402 and the clock forwarding 410 and 412, an IC designer may implement well-controlled timing constraints to control these 3D paths (e.g., by scripting or by entering timing constraints manually) at both Synthesis and PnR phases of the EDA implementation flow. To affect this control, there may be only three main timing consideration paths to control per memory bank 406A-406D. For example, one main timing consideration path may correspond to clock to router flop clock in (CLK to router_flop_clk_in). Creating input and output timing constraints for these paths for the respective pins may be straightforward in the SOTA EDA tool flow. Since all the memory banks 406A-406D may be hardened (e.g., all pin delays are known), no memory banks 406A-406D may communicate directly with each other, and all the paths may be flop-to-flop connections with no unknown combinatorial 3D loops. Other main timing consideration paths may include clock to memory clock in (CLK to memory_clk_in) and router data port to/from memory data port (Router_Data port to/from Memory_Data port). As a result, the EDA tool may perform STA timing verification on multi-die, multi-corner at the top-level without the problem of falling into an unsolvable 3D cross-die timing path. Additionally, any timing issues encountered at the top-level may be iterated on as necessary following the same steps to adjust the paths, to finally fix and verify all the hold and setup timing closure of the 3D cross-die paths.

FIG. 5 illustrates an exemplary scaling and design method to multiple instances on an example 3DIC partitioned SRAM 500 of 32× memory banks 502, with 16× memory banks 504A-504F implemented in a first die 506 and 16× memory banks 508A-508F implemented in a second die 510. As shown in FIG. 5, an example implementation of the disclosed systems and methods relates to 3D clock forwarding for a 3D SRAM structure spanning across two stacked dies (e.g., stacking with hybrid-bump 512 technology). By repeating the disclosed systems and methods on all the logic routers and the 3D SRAM partitions (e.g., memory banks 502), the 3D variation aware clock-forwarding and data path construction may scale to any number of resulting 3D partitions. As an example, if each memory bank 502 is 1 MB, then the 3D SRAM may implement a 32 MB embedded and stacked memory sub-system of the SoC. FIG. 5 shows an example of 32 MBs of 3D shared SRAM, with 16 MBs of memory implemented on both dies. However, an arbitrary number of banks could be implemented on either of the dies without the need to equalize the number of banks on both dies or without the need for power-of-two numbers, since the disclosed systems and methods are applicable to any or all of these possible design choices.

Advantageously, the disclosed systems and methods may implement multi-die, multi-corner variation-aware 3D-stacking with clock forwarding to enable straightforward and feasible 3D cross-die data path balancing for state-of-the-art EDA tools and chip signoff flows. Compared to a 2D flow that implements 2×2D dies, the disclosed systems and methods may result in the EDA tool implementing a reduced number of clock buffers and data path buffers for 3D cross-die passings to close hold and setup timing under multi-corner/-die variations. As a result, the disclosed systems and methods may enable a faster and feasible path to close timing at the cross-die level and minimize the added data path and clock-tree balancing buffers. In addition to 3DIC implementation feasibility and a faster-to-final implementation design cost reduction, a minimized number of buffers may further reduce the clock and signal power at the chip level.

The disclosed systems and methods relating to clock forwarding may exhibit numerous observable features. For example, such features may be observed when analyzing the 3D cross-paths of a 3DIC fabricated with hybrid-bump technology. If partitioned subsystems (e.g., 3D SRAM, etc.) implement a single clock forwarded per partition by construction, if the 3D partitions only communicate with a common logic (e.g., a router or a similar control/comms block), and if the 3D-cross communication is implemented with sequential-to-sequential only paths, these observable features may indicate use of the disclosed systems and methods relating to clock forwarding.

Turning now to FIG. 6 and FIG. 7, implementations of the disclosed systems and methods may relate to an extendable network on chip (NoC). NoC may be an interconnect fabric that connects multiple sub-systems in an SoC that allows for communication of multiple blocks over a network of routers. NoCs typically may employ different communication protocols such as AMBA/AXI, APB, OCP, etc., and may have a customized number of signal bit-width depending on the needs of the architecture. Routers may control the traffic of signal packages, may employ traffic control mechanisms such as back-pressure or different routing protocols over the interconnect network (e.g., any kind of custom network topology such as mesh, torus, etc.), and typically may be pipelined to achieve any target clock frequency that is needed. Spanning over the SoC, NoC also may employ different clock frequencies, power domains, voltage domains, etc. as needed. Extending the NoC to 3D for a 3D stacked SoC may keep the sub-system communications intact.

The disclosed systems and methods may provide a 3D extendable NoC to connect, over hybrid-bumps, with flexible connection options post-manufacturing. For example, by using hybrid-bump 3D interconnects, the NoC may be extended to off-chip. Implementations that relate to an extendable NoC may be fully digital and, therefore, fully achievable using conventional 2D/3D EDA tools, thus eliminating any additional design cost to the designer. The NoC components in this approach may be socket protocol agnostic, which may enable a flexible or “plug & play” type of NoC extension across 3D. This approach, therefore, may improve system modularity, and the traffic may be dynamically dispatched at runtime through all available NoC ports/IOs.

FIG. 6 illustrates an exemplary extension 600 of a network on chip (NoC) 602 connection to off-die by using 3D hybrid bumps 604 to enable mitigation of external NoC communication bottleneck when compared to 2D input/outputs (IOs). As shown in FIG. 6, connecting a high bitwidth NoC connection (e.g., typically 128 bits or 256 bits) to a conventional IO port 606 will create a bottleneck 608 on the off-die communication bandwidth, as it is not physically feasible to implement the high number of matching IO ports due to area constraints (IO port 606 includes multiple components such as IO pads, bumps, specialized IO drivers, etc.). For an SoC implementing the required large number of dedicated IO ports with the area overhead, a high power consumption overhead may be expected due to the need of specialized IO drivers that are driving large loads. Moreover, even if the number of IO ports match the high NoC bitwidth, the external communication speed that may be achieved by the IO drivers typically may be less than the on-chip internal NoC 610 communication speed, again limiting the overall achievable bandwidth.

The disclosed systems and methods may use 3D hybrid-bumps 604 to mitigate this issue, where a NoC may be extended using 3D hybrid-bump pins to limit or even eliminate the cause of internal-to-external off-die communication bottleneck. For example, NoC communication bitwidth may be matched with 3D hybrid-bump pin density, as the new <5 μm or <10 μm pitch hybrid-bump (i.e., hybrid-bump) 3D stacking fabrication technologies may allow for very high density interconnects. As a result, the NoC may extend to 3D off-die, while still matching the on-die signal bit-width. Additionally, the hybrid-bumps may require a very low top-level metal area for landing (e.g., in the order of their ^{˜}5 μm pitch center to center), and therefore incur very minimal additional parasitics (e.g., capacitance and resistance). As a result, the disclosed systems and methods may avoid the need for drivers from the NoC router to drive a load composed of wire ascending to top-level metal, plus hybrid bump, plus wire descending down to bottom layer metal, plus gate capacitance of the load, as described above with reference to FIG. 3. As the additional parasitic RC of the hybrid-bumps may be minimal, the total RC of the 3D load may become comparable to a 2D internal wire and a typical gate as described above with reference to FIG. 2. As a result, the extended NoC drivers may be implemented with traditional standard cells using a traditional digital EDA flow (e.g., conventional RTL design, Synthesis, and PnR flows).

FIG. 7 illustrates an exemplary extension 700 of 3D NoC to achieve speed and energy efficiency comparable to 2D internal NoC communication. Since the drivers 702 may be standard cells configured to drive a load comparable to a load of an internal gate 704, the EDA tool may match the internal clock speed in a conventional fashion (e.g., closing timing for setup and hold times across dies). As a result, the 3D extended-NoC communication speed across stacked dies also may match the same 2D on-die NoC communication speed, as shown in FIG. 7. Also, by matching the bitwidth and the clock speed, the 3D extended-NoC may eliminate any possible reduction to the overall NoC bandwidth due to a bottleneck (e.g., number of bits transferred in a second). Finally, since the disclosed systems and methods may use the traditional state-of-the-art EDA flows to implement standard cell based drivers that are driving comparable loads to internal wires, the energy spent for cross-die 3D communication also may be comparable to the 2D on-die communication energy of the same NoC as shown in FIG. 7. Compared to specialized IO drivers, the disclosed systems and methods may reduce drastically the power consumption of extending the NoC.

The disclosed systems and methods relating to extendable network on chip (NoC) may provide benefits that include better communication BW and energy consumption and scalability extending to heterogeneous stacking. For example, compared to traditional methods of extending the NoC off-die using 2D IOs (for in-package 3D stacking), the 3D-extended NoC via hybrid-bumps may eliminate the need for communication bandwidth bottleneck and therefore match the internal on-die NoC bandwidth. This capability may further provide an opportunity to improve SoC-level communication parallelism, which may enable more flexibility and architecture-level design decision options for a system designer to allocate better memory-access policies to achieve the best efficiency for chosen target metrics/specifications. In addition, since the hybrid-bumps add negligible parasitic RC to the already RC dominated global wires that NoC typically use, the energy-efficiency of 3D-extended NoC via hybrid-bumps may result in similar energy consumption to internal on-die NoC communication energy. In certain cases, the 3D-extended NoC may even provide better energy-efficiency compared to on-die 2D internal communications energy, as 3D wires enable shortening the global-wire distances drastically by traveling in an extremely short Z direction to reduce X and Y distances. This reduction may depend on how the SoC architecture and floor planning is designed.

Additionally, extending the NoC off die may be scalable to other use-cases, since by construction it uses traditional digital IC design flows. Therefore, the 3D extended NoC further enables various capabilities. For example, one such capability may include extending the NoC to a heterogeneous 3D stacked die, where using another technology allows for better SoC-level advantages. In this context, heterogenous 3D stacking may refer to stacking multiple dies fabricated in different technology nodes. As an example, a reduced leakage technology may be based on an older technology node stacked on a highly scaled technology node to achieve the best performance and power at the system level. Another capability may include extending the NoC to a dense 3D memory die, such as DRAM, SRAM, RRAM, etc. A further capability may include implementing the NoC as an open (e.g., unconnected) off-die port, and then stacking another die on top opportunistically later on after fabrication. A prerequisite for this capability may include matching the physical location and communication protocol of an additional stacked die to that of the original base die. Since the original die may be built with conventional digital EDA flows and tools, the stacked die may have a different clock frequency or different power-domains as long as it implements conventional Clock-Domain-Crossing (CDC) circuits and conventional UPF flows.

The disclosed systems and methods relating to extending the NoC off-die may exhibit numerous observable features. For example, if the SoC is fabricated with hybrid-bump technology as a 3DIC system, if there is a NoC (or similar communication network) implemented on the main die (or base die) to connect subsystems, and if the NoC may communicate with any subsystem in the stacked die (or die on top) without any BW drop or power-overhead due to specialized drivers, these observable features may indicate use of the disclosed systems and methods relating to extending the NoC off-die.

Turning to FIGS. 8-12, implementations of the disclosed systems and methods may relate to compiler-agnostic 3D hardware IP extension for added memory and/or functionality with hybrid bonding technology. Extending the memory and/or compute capabilities of an existing IP in 3D may mean that the design and implementation changes of the IP may require the firmware and the compiler to capture these changes. Capturing such changes may be needed so that the existing IP may be used as-is with minimal modifications to the previously existing and functionally verified codebases and IP-specific instructions. If the firmware and the compiler cannot make this transition seamlessly to the programmer and/or the SoC user, then the existing codes that work in the 2D IP ecosystem may fail in the 3D-extended versions of the same IPs. To avoid the costly changes to the firmware and compiler (e.g., in terms of design cost, resource cost, as well as verification time costs) that have the potential to affect the correct functionality of existing codebase for the extended IPs, the disclosed systems and methods may provide a 3D design methodology that incurs minimal compiler changes, which may allow the same software stack to be used for both existing 2D IP and a 3D extended IP. As a result, this approach may allow for minimal to no modifications to the existing codebase when the IPs are extended to 3D-stacking.

For this approach, two data path signal communication flows for IP-level control may be considered. For example, a first control type (Control Type #1) may correspond to a pipelined data path design with an internal IP control mechanism based on deterministic cycle counts (whereby sequential elements work in lock-step with respect to cycle counts for correct functionality), which may be considered as a form of static-cycle control. In contrast, a second control type (Control Type #2) may correspond to a data path design utilizing Request/Acknowledge hand-shake based (e.g., Ready/Valid based, etc.) communication flow that allows for an internal IP control mechanism with non-deterministic cycle counts, which may be considered as a form of dynamic-cycle control. For brevity, Control Type #1 and Control Type #2 may be referred to herein as CTRL1 and CTRL2, respectively. CTRL1 and CTRL2 circuit control mechanisms are depicted at high-level in FIGS. 8 and 9, respectively.

FIG. 8 illustrates an exemplary static-cycle control flow 800 for a pipelined data path 802. As shown in FIG. 8, a typical data path 802 controlled by CNTRL1 type flow 800 is designed with a deterministic cycle count control mechanism, such that the control block 804 (e.g., a finite-state-machine (e.g., an FSM)) may require cycle counters to determine the flow of the signals, keep track of which state the control block 804 is in, and also to generate start/stop/standby control signals 806A, 806B, and 806C for the pipeline stages and/or the logical function blocks 808A and 808B. The pipeline stages may include sequential elements applicable for pipelining such as flip-flops, latches, register files, SRAMs, etc. FIG. 8 depicts an example to illustrate an IP data path 802 controlled by CNTRL1 mechanism, whereby each pipeline stage works in lock-step with other stages to function correctly. Other micro-architectures and control circuit blocks may also work similarly under CNTRL1 flow, where the exact cycle counts may be needed for correct functionality. Typically, a hardware accelerator IP for a specialized function (e.g., a graphics pipeline stage, a Multiply-Accumulate (MAC) array based Machine Learning (ML) accelerator, or similar other special-purpose IPs) may be implemented with CNTRL1 type flow.

FIG. 9 is an illustration of an exemplary dynamic-cycle control flow 900 for a ready/valid based communications protocol based data path 902. As shown in FIG. 9, a data path 902 controlled by CNTRL2 type flow may be designed with a non-deterministic cycle mechanism, where each function block 904A and 904B implements a Ready/Valid type of request and acknowledgement based two-way hand-shake communication 906A-906D to send and/or receive data 908A-908D within the data path 902. Therefore, the control block 910 (e.g., an FSM or other applicable control circuit blocks) may not need to keep track of clock cycles in a cycle-accurate way and may only need to keep track of the overall states of the function blocks 904A and 904B (e.g., “ready” vs. “busy”) to determine IP-level states and control the correct functionality of the IP data path 902. Any applicable circuit may be implemented as the micro-architecture for CNTRL2 type flow, as long as an applicable hand-shake mechanism is implemented in the data path 902 to pass and collect data in between function blocks 904A and 904B.

Typically, an IP that has multiple sub-hierarchies dedicated to different tasks (e.g., an IP with two parallel-working components such as a micro-controller and a specialized function accelerator, or other similar IPs), or an IP that is heavily partitioned (e.g., a partitioned, multi-bank/multi-partition embedded memory block, or other similar IPs) may be implemented with CNTRL2 type flow.

The disclosed systems and methods may provide a micro-architecture design approach to incur minimal compiler changes for an IP when the IP is extended to 3D for more compute and/or memory capabilities. For data paths with CNTRL_1 type control flow, since CNTRL1 data path will typically be pipelined for deterministic cycle-count type control flow for correct functionality, the 3D extension may be made as a part of the pipeline stages. Additionally, for adding additional block(s) in 3D within the IP abstraction, new pipeline stages may be implemented, adding to the existing pipeline stages. Also, 3D-die crossing may be strategically placed within one of the pipeline stages. The exact pipeline stage may be consistent throughout the IP when there are multiple pipe-stages branching in the data path. This consistency may ensure that the cycle determinism of the CNTRL1 type control flow is preserved. If the 3D-die crossing creates unequal pipeline stages in 2D and 3D dies, then “bubble” (e.g., empty) pipe-stages may be implemented to make sure the lock-step control mechanism is not broken.

Alternatively, the pipeline stages may be re-balanced, as long as the added number of pipe-stages match in all branches. This option, however, may cause a re-design of the functions and possibly RTL definitions, leading to additional design cost. An example data path in 3D illustrating the added pipeline stages to an IP 1000 in 2D and the same IP 1100 extended in 3D by adding two empty pipeline stages 1102A and 1102B are shown in FIGS. 10 and 11, respectively. The two empty pipeline stages may accommodate for the CNTRL_1 cycle dependency to mitigate drastic changes to the compiler and firmware. As a result of this approach, the compiler may incur minimal changes. The deterministic timing of the control block may be adjusted with the added number of pipelines and adjusted for the final start/stop cycles. Compiler knowledge for the rest of the IP control may be left as-is. The compiler may only need to know that a new capability is added (e.g., memory or compute).

FIG. 12 illustrates exemplary dynamic-cycle data paths 1200 with flexible function blocks using hand-shake communication (e.g., Ready/Valid, Req/ACK, etc.). For data paths with CNTRL_2 type control flow, since the CNTRL2 data path may typically be a flexible control flow based on hand-shake protocols for correct functionality, the 3D extension may be straightforward to implement as a part of the hand-shake flow. For adding additional block(s) in 3D within the IP abstraction, the added extension blocks may be implemented as another Ready/Valid flow capable functional block. A 3D-die crossing may be implemented by making sure that the cross-die communication happens at the hand-shake interface for the functional blocks. FIG. 12 illustrates how an example 2D IP 1202 with CNTRL2 control type may be extended to 3D with new functional capabilities by placing expansion functional blocks crossing-die at a utilized handshake boundary to mitigate drastic changes to the compiler. This approach may provide seamless integration of a new function/memory extension for the CNTRL2 type data path IP 1204. As long as the cross-die passing is isolated at the hand-shake mechanism at the micro-architecture level, the overall data path control flow CNTRL2 will work in an agnostic manner (e.g., adding a new functional block in 2D vs 3D may have the same control mechanism for the control block). As a result, the compiler may need no specific adjustments for the control flow since everything works in ack/request type of communications, and only the newly added capabilities may be added to the compiler as needed.

Advantageously, the disclosed systems and methods may provide a way to incur minimal or no changes to the compiler's understanding of timing control of the micro-architecture, for when an existing 2D IP is extended to 3D for extended capabilities (e.g., added functionality and/or memory capacity). As a result, the existing codebase for the 2D IP (e.g., the legacy code, etc.) may continue working with minimal or no additional changes when deployed on the 3D-extended IP. The disclosed systems and methods may target to main control flows that are typically seen in SoC sub-system IPs (e.g., CNTRL1: A data path control flow based on deterministic cycle counts (i.e., static-cycle control) and/or CNTRL2: A data path control flow based on Request/Acknowledge type hand-shake protocols (i.e., dynamic-cycle control)). For both of these conventional control flows, the disclosed systems and methods may provide a way to extend the IP to a 3D stacked die for added memory and/or functionality with minimal changes to the existing compiler and existing codebase/instructions related to the original IP.

The disclosed systems and methods relating to compiler-agnostic 3D hardware IP extension for added memory and/or functionality with hybrid bonding technology may exhibit observable features. For example, if the compiler remains as-is between a 2D native IP and the same IP abstraction in a 3D die (e.g., with more capability, more resources, or more memory), these observable features may indicate use of the disclosed systems and methods relating to compiler-agnostic 3D hardware IP extension for added memory and/or functionality with hybrid bonding technology.

As set forth above, the disclosed systems and methods may three-dimensionally stack SoCs with face-to-face hybrid bonding. For example, a semiconductor device may include a first die including a driver gate driving a first via ladder coupled to a first top metal layer and a second die including a load gate coupled to a second via ladder coupled to a second top metal layer. The first die and the second die may be stacked three-dimensionally using face-to-face hybrid bonds to couple the first top metal layer to the second top metal layer. Both dies may include both driver and load gates when stacked to achieve signal driving in both directions (i.e., top die-to-bottom die and bottom die-to-top die). Various implementations of this type of semiconductor device may include three-dimensional interconnects that correctly close timing at a SoC level, three-dimensional extension of an on-chip data communication fabric, and/or three-dimensional extension of hardware accelerators and/or static random access (SRAM) memories with minimal impact on an existing firmware and compiler for the SoC.

### EXAMPLE EMBODIMENTS

Example 1: A semiconductor device may include a first die including a driver gate configured to drive a first via ladder coupled to a first top metal layer and a second die including a load gate coupled to a second via ladder coupled to a second top metal layer, wherein the first die and the second die are stacked three-dimensionally using face-to-face hybrid bonds to couple the first top metal layer to the second top metal layer.

Example 2: The semiconductor device of Example 1, wherein partitioned subsystems of a circuit of the semiconductor device forward a single clock per partition.

Example 3: The semiconductor device of any of Examples 1 and 2, wherein partitions of the partitioned subsystems communicate exclusively with a common logic implemented in one of the first die or the second die.

Example 4: The semiconductor device of any of Examples 1 to 3, wherein data communication across the first die and the second die is implemented using sequential-to-sequential only data paths.

Example 5: The semiconductor device of any of Examples 1 to 4, wherein a network on chip in the first die connects partitioned subsystems of a circuit of the semiconductor device and cross die data communication by the network on chip has a bit width matched to a pin density of the face-to-face hybrid bonds.

Example 6: The semiconductor device of any of Examples 1 to 5, wherein all circuit drivers of the circuit correspond to standard cell drivers.

Example 7: The semiconductor device of any of Examples 1 to 6, further including a data path pipelined for a deterministic cycle count type control flow, wherein a three-dimensional extension of the data path is implemented by adjusting a deterministic timing data path by addition of additional pipeline stages and placement of a three-dimensional die crossing within one the additional pipeline stages.

Example 8: The semiconductor device of any of Examples 1 to 7, wherein the additional pipeline stages are empty pipeline stages.

Example 9: The semiconductor device of any of Examples 1 to 8, wherein the additional pipeline stages are rebalanced pipeline stages.

Example 10: The semiconductor device of any of Examples 1 to 9, further including a data path having a flexible control flow based on at least one hand-shake protocol, wherein a three-dimensional extension of the data path is implemented as part of the at least one hand-shake protocol by addition of functional blocks and implementation of cross-die communication at a hand-shake interface for the functional blocks.

Example 11: A method may include providing a first die including a driver gate configured to drive a first via ladder coupled to a first top metal layer, providing a second die including a load gate coupled to a second via ladder coupled to a second top metal layer, and stacking the first die and the second die three-dimensionally using face-to-face hybrid bonds to couple the first top metal layer to the second top metal layer.

Example, 12: The method of Example 11, wherein partitioned subsystems of a circuit of the semiconductor device forward a single clock per partition.

Example 13: The method of any of Examples 11 and 12, wherein partitions of the partitioned subsystems communicate exclusively with a common logic implemented in one of the first die or the second die.

Example 14: The method of any of Examples 11 to 13, wherein data communication across the first die and the second die is implemented using sequential-to-sequential only data paths.

Example 15: The method of any of Examples 11 to 14, wherein a network on chip in the first die connects partitioned subsystems of a circuit of the semiconductor device and cross die data communication by the network on chip has a bit width matched to a pin density of the face-to-face hybrid bonds.

Example 16: The method of any of Examples 11 to 15, wherein all circuit drivers of the circuit correspond to standard cell drivers.

Example 17: The method of any of Examples 11 to 16, further including configuring a data path pipelined for a deterministic cycle count type control flow and implementing a three-dimensional extension of the data path by adjusting a deterministic timing data path by addition of additional pipeline stages and placement of a three-dimensional die crossing within one the additional pipeline stages.

Example 18: The method of any of Examples 11 to 17, wherein the additional pipeline stages are empty pipeline stages or rebalanced pipeline stages.

Example 19: The method of any of Examples 11 to 18, further including configuring a data path having a flexible control flow based on at least one hand-shake protocol and implementing a three-dimensional extension of the data path as part of the at least one hand-shake protocol by addition of functional blocks and implementation of cross-die communication at a hand-shake interface for the functional blocks.

Example 20: A system may include a display device and a semiconductor device configured to process images rendered to the display device, wherein the semiconductor device includes a first die including a driver gate configured to drive a first via ladder coupled to a first top metal layer and a second die including a load gate coupled to a second via ladder coupled to a second top metal layer, and the first die and the second die are stacked three-dimensionally using face-to-face hybrid bonds to couple the first top metal layer to the second top metal layer.

Embodiments of the present disclosure may include or be implemented in-conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 1300 in FIG. 13) or that visually immerses a user in an artificial reality (such as, e.g., virtual-reality system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, augmented-reality system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While augmented-reality system 1300 includes two displays, embodiments of this disclosure may be implemented in augmented-reality systems with a single NED or more than two NEDs.

In some embodiments, augmented-reality system 1300 may include one or more sensors, such as sensor 1340. Sensor 1340 may generate measurement signals in response to motion of augmented-reality system 1300 and may be located on substantially any portion of frame 1310. Sensor 1340 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

In some examples, augmented-reality system 1300 may also include a microphone array with a plurality of acoustic transducers 1320 (A)-1320(J), referred to collectively as acoustic transducers 1320. Acoustic transducers 1320 may represent transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(1) and 1320(J), which may be positioned on a corresponding neckband 1305.

In some embodiments, one or more of acoustic transducers 1320(A)-(J) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While augmented-reality system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), augmented-reality system 1300 may simulate binaural hearing and capture a 3D stereo sound field around about a user's head. In some embodiments, acoustic transducers 1320(A) and 1320(B) may be connected to augmented-reality system 1300 via a wired connection 1330, and in other embodiments acoustic transducers 1320(A) and 1320(B) may be connected to augmented-reality system 1300 via a wireless connection (e.g., a BLUETOOTH connection). In still other embodiments, acoustic transducers 1320(A) and 1320(B) may not be used at all in conjunction with augmented-reality system 1300.

Acoustic transducers 1320 on frame 1310 may be positioned in a variety of different ways, including along the length of the temples, across the bridge, above or below display devices 1315(A) and 1315(B), or some combination thereof. Acoustic transducers 1320 may also be oriented such that the microphone array is able to detect sounds in a wide range of directions surrounding the user wearing the augmented-reality system 1300. In some embodiments, an optimization process may be performed during manufacturing of augmented-reality system 1300 to determine relative positioning of each acoustic transducer 1320 in the microphone array.

In some examples, augmented-reality system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to augmented-reality system 1300. In the embodiment of FIG. 13, neckband 1305 may include two acoustic transducers (e.g., 1320 (l) and 1320(J)) that are part of the microphone array (or potentially form their own microphone subarray). Neckband 1305 may also include a controller 1325 and a power source 1335.

Acoustic transducers 1320(I) and 1320(J) of neckband 1305 may be configured to detect sound and convert the detected sound into an electronic format (analog or digital). In the embodiment of FIG. 13, acoustic transducers 1320 (l) and 1320(J) may be positioned on neckband 1305, thereby increasing the distance between the neckband acoustic transducers 1320(I) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or augmented-reality system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which augmented-reality system 1300 includes an inertial measurement unit, controller 1325 may compute all inertial and spatial calculations from the IMU located on eyewear device 1302. A connector may convey information between augmented-reality system 1300 and neckband 1305 and between augmented-reality system 1300 and controller 1325. The information may be in the form of optical data, electrical data, wireless data, or any other transmittable data form. Moving the processing of information generated by augmented-reality system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium-ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 1400 in FIG. 14, that mostly or completely covers a user's field of view. Virtual-reality system 1400 may include a front rigid body 1402 and a band 1404 shaped to fit around a user's head. Virtual-reality system 1400 may also include output audio transducers 1406(A) and 1406(B). Furthermore, while not shown in FIG. 14, front rigid body 1402 may include one or more electronic elements, including one or more electronic displays, one or more inertial measurement units (IMUs), one or more tracking emitters or detectors, and/or any other suitable device or system for creating an artificial-reality experience.

Artificial reality systems may include a variety of types of visual feedback mechanisms. For example, display devices in augmented-reality system 1300 and/or virtual-reality system 1400 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 1300 and/or virtual-reality system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 1300 and/or virtual-reality system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A semiconductor device comprising:
a first die including a driver gate configured to drive a first via ladder coupled to a first top metal layer; and
a second die including a load gate coupled to a second via ladder coupled to a second top metal layer,
wherein the first die and the second die are stacked three-dimensionally using face-to-face hybrid bonds to couple the first top metal layer to the second top metal layer.

2. The semiconductor device of claim 1, wherein partitioned subsystems of a circuit of the semiconductor device forward a single clock per partition.

3. The semiconductor device of claim 2, wherein partitions of the partitioned subsystems communicate exclusively with a common logic implemented in one of the first die or the second die.

4. The semiconductor device of claim 3, wherein data communication across the first die and the second die is implemented using sequential-to-sequential only data paths.

5. The semiconductor device of claim 1, wherein a network on chip in the first die connects partitioned subsystems of a circuit of the semiconductor device and cross die data communication by the network on chip has a bit width matched to a pin density of the face-to-face hybrid bonds.

6. The semiconductor device of claim 5, wherein all circuit drivers of the circuit correspond to standard cell drivers.

7. The semiconductor device of claim 1, further comprising a data path pipelined for a deterministic cycle count type control flow, wherein a three-dimensional extension of the data path is implemented by adjusting a deterministic timing data path by addition of additional pipeline stages and placement of a three-dimensional die crossing within one the additional pipeline stages.

8. The semiconductor device of claim 7, wherein the additional pipeline stages are empty pipeline stages.

9. The semiconductor device of claim 7, wherein the additional pipeline stages are rebalanced pipeline stages.

10. The semiconductor device of claim 1, further comprising a data path having a flexible control flow based on at least one hand-shake protocol, wherein a three-dimensional extension of the data path is implemented as part of the at least one hand-shake protocol by addition of functional blocks and implementation of cross-die communication at a hand-shake interface for the functional blocks.

11. A method comprising:
providing a first die including a driver gate configured to drive a first via ladder coupled to a first top metal layer;
providing a second die including a load gate coupled to a second via ladder coupled to a second top metal layer; and
stacking the first die and the second die three-dimensionally using face-to-face hybrid bonds to couple the first top metal layer to the second top metal layer.

12. The method of claim 11, wherein partitioned subsystems of a circuit of a semiconductor device forward a single clock per partition.

13. The method of claim 12, wherein partitions of the partitioned subsystems communicate exclusively with a common logic implemented in one of the first die or the second die.

14. The method of claim 13, wherein data communication across the first die and the second die is implemented using sequential-to-sequential only data paths.

15. The method of claim 11, wherein a network on chip in the first die connects partitioned subsystems of a circuit of a semiconductor device and cross die data communication by the network on chip has a bit width matched to a pin density of the face-to-face hybrid bonds.

16. The method of claim 15, wherein all circuit drivers of the circuit correspond to standard cell drivers.

17. The method of claim 11, further comprising:
configuring a data path pipelined for a deterministic cycle count type control flow; and
implementing a three-dimensional extension of the data path by adjusting a deterministic timing data path by addition of additional pipeline stages and placement of a three-dimensional die crossing within one the additional pipeline stages.

18. The method of claim 17, wherein the additional pipeline stages are at least one of:
empty pipeline stages; or
rebalanced pipeline stages.

19. The method of claim 11, further comprising:
configuring a data path having a flexible control flow based on at least one hand-shake protocol; and
implementing a three-dimensional extension of the data path as part of the at least one hand-shake protocol by addition of functional blocks and implementation of cross-die communication at a hand-shake interface for the functional blocks.

20. A system comprising:
a display device; and
a semiconductor device configured to process images rendered to the display device, wherein the semiconductor device includes:
a first die including a driver gate configured to drive a first via ladder coupled to a first top metal layer; and
a second die including a load gate coupled to a second via ladder coupled to a second top metal layer,
wherein the first die and the second die are stacked three-dimensionally using face-to-face hybrid bonds to couple the first top metal layer to the second top metal layer.
